(19) United States
(12) Patent Application Publication
(10) Pub. No.: US 2003/0128761 A1
(43) Pub. Date: Jul. 10, 2003

(54) Image and video coding

(76) Inventor: Minhua Zhou, Plano, TX (US)

Correspondence Address: TEXAS INSTRUMENTS INCORPORATED, P O BOX 655474, M/S 3999, DALLAS, TX, 75265

(21) Appl. No.: 10/314,927

(22) Filed: Dec. 9, 2002

Related U.S. Application Data
(60) Provisional application No. 60/340,727, filed on Dec. 7, 2001.

(51) Int. Cl. H04N 7/12

(52) U.S. Cl. 375/240.16; 375/240.24

(57) ABSTRACT

Video encoding motion compensation including prediction reference blocks from two preceding pictures with the prediction block selected from either reference block or from an average of the two reference blocks.

### CROSS REFERENCE TO RELATED APPLICATIONS

This application claims priority from provisional application Appl. No. 60/340,727, filed Dec. 07, 2001. The following pending US patent applications disclose related subject matter and have a common assignee with the present application: Ser. No. 09/ . . . , filed . . .

### BACKGROUND OF THE INVENTION

This invention relates to coding methods, and more particularly to bi-directional coding as is useful with motion compensation coding and related systems.

Many methods exist to compress images/video, such as JPEG for still images and H.26x/MPEGx for video sequences. Video compression may exploit temporal redundancy by motion compensation in addition to image compression. In block-based video compression, such as H.261, H.263, MPEG1, MPEG2, and MPEG4, or image compression, such as JPEG, a picture is decomposed into macroblocks. Each macroblock contains a certain number of 8×8 blocks, depending upon the chroma-format used. For example, in the case of 4:2:0 chroma-format a macroblock is made up of four 8×8 luminance blocks (i.e., 16×16 pixels) and two 8×8 chrominance blocks (each located as a subsampling of the 16×16). An 8×8 DCT (discrete cosine transform) or wavelet transform is used to convert the blocks of pixel values into frequency domain blocks of transform coefficients for quantization; this permits reduction of the number of bits required to represent the blocks. FIG. 7 depicts block-based video encoding using DCT. The DCT-coefficients blocks are quantized, scanned into a 1-D sequence, encoded by using variable length coding (VLC), and put into the transmitted bitstream. The frame buffer contains the reconstructed prior frame used for reference blocks. Additionally, the motion vectors are also encoded and transmitted along with overhead information. A decoder just reverses the encoder operations and reconstructs motion-compensated blocks by using the motion vectors to locate reference blocks in previously-decoded frames (pictures).

Video temporal compression relates successive pictures (images) in a sequence by various methods including motion compensation which uses block-based predictions. Indeed, in the block-based coding methods, such as H.26x/MPEGx, pictures in a sequence are encoded into one of three picture types: I-pictures (intra-coded), P-pictures (predictive), and B-pictures (bi-directional, interpolative). The coding of an I-picture is independent of other pictures (and thus any image coding method could be applied). A P-picture is first predicted from its reference picture (a previous I- or P-picture) using the macroblock based forward prediction mode (predicting a target macroblock in the current P-picture from a reference macroblock of the reference picture); then the motion-compensated difference picture plus the associated motion vectors (the displacements of the reference macroblock locations to from the target macroblock locations) are encoded. A B-picture has two reference pictures (see FIG. 2), the forward reference picture from the past and the backward reference picture from the future. Similar to a P-picture, motion-compensated prediction is applied to the B-picture first, then the prediction error and motion vectors are encoded into the bitstream.

A B-picture supports three basic modes, forward prediction, backward prediction, and bi-directional prediction. In the forward or backward prediction mode, the prediction blocks are generated from the forward or backward reference picture, respectively, by using the related forward or backward motion vectors, respectively. In the bi-directional mode, the prediction blocks are generated from the forward AND backward reference pictures by performing the forward prediction, the backward prediction and then averaging the two predictions pixel by pixel.

For motion compensation (MC) which uses motion estimation (ME) of successive video frames, inverse-quantization and IDCT are needed for the feedback loop. Except for MC, all the function blocks in FIG. 7 operate on 8×8 block basis.

H.26L is a new video compression video standard being developed by ITU-T which offers much higher coding efficiency (about 30-50% additional bit-rate reduction at the same coding qualities) than MPEG-4 SP. A typical application of H.26L could be wireless video on demand, in which the bandwidth is so limited that a coding standard of high compression ratio is strongly desired.

The basic coding techniques in H.26L are still motion compensated prediction, transform, quantization and entropy coding as illustrated in FIG. 7. However, H.26L differs from MPEG4/H.263 in many details. One of major differences lies in the transform and quantization. Instead of 8×8 DCT transforms, H.26L may use a 4×4 integer transform for the residual coding of the residual blocks generated either by using motion compensation for inter-coded macroblocks or by using intra prediction for intra-coded macroblocks.

### SUMMARY OF THE INVENTION

The invention provides motion-compensated video with a picture predicted from 1 or 2 prior pictures.

This has advantages including video coding efficiency.

### BRIEF DESCRIPTION OF THE DRAWINGS

The drawings are heuristic for clarity.

FIG. 1 is a flow diagram of a preferred embodiment method.

FIGS. 2-4 illustrate motion compensation prediction relations.

FIG. 5 shows various macroblock partitions into subblocks

FIG. 6 compares H.26L and a preferred embodiment method.

FIG. 7 illustrates DCT block-based motion compensation.

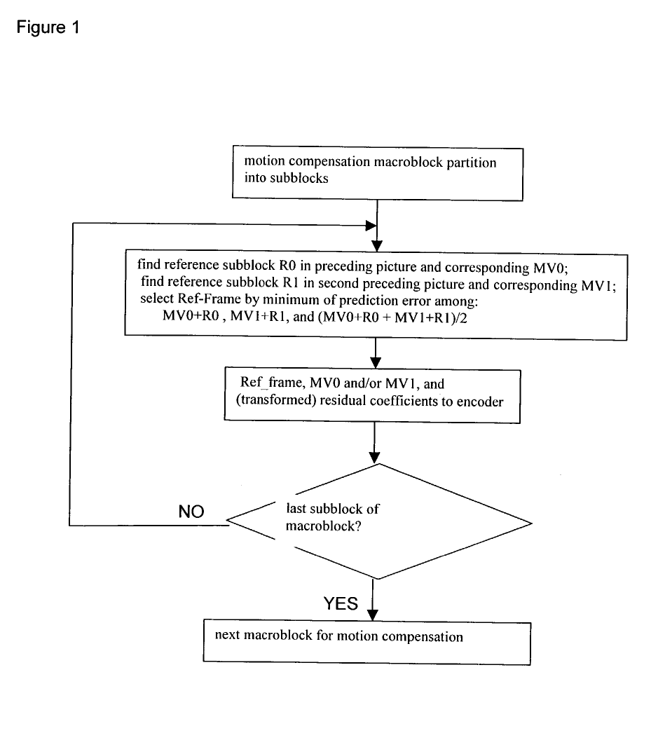

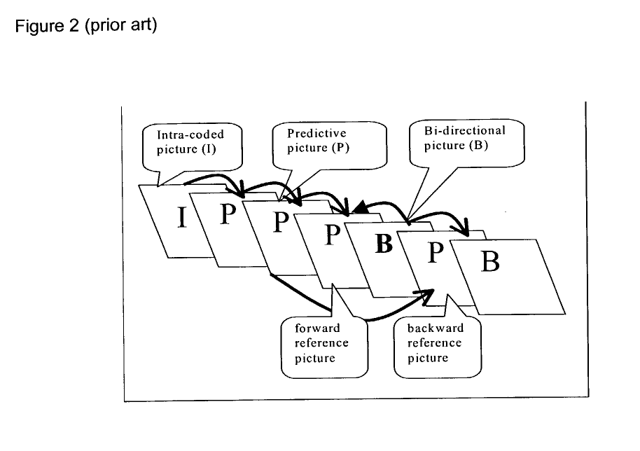

### DESCRIPTION OF THE PREFERRED EMBODIMENTS

1. Overview

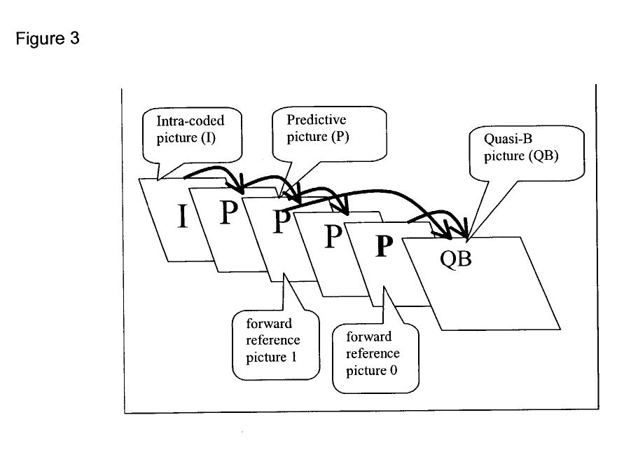

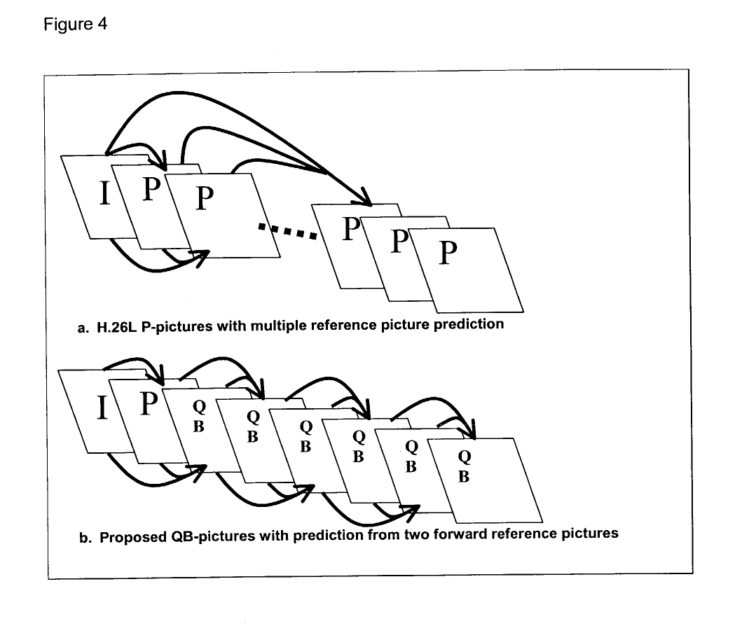

Preferred embodiment methods provide a Quasi-B picture (QB-picture) analogous to a B-picture in motion-compensated video coding. In particular, a QB-picture has two reference pictures, but the two reference pictures are both from the past; see FIGS. 3, 4(b). The two reference pictures, denoted forward reference pictures 0 and 1, could be any pictures that are encoded before a QB-picture. A special case is that the two reference pictures are the two most recently encoded pictures before the QB-picture. There are two basic prediction modes in a QB-picture, namely, forward prediction from either reference picture 0 or reference picture 1, and bi-directional (linear combinational) prediction from both reference picture 0 and reference picture 1. In the bi-directional prediction mode, the prediction blocks are generated by computing the forward predictions from both reference picture 0 and reference picture 1, and then averaging the two predictions pixel by pixel.

Compared to a P-picture which supports the forward prediction mode only, a QB-picture offers higher coding efficiency due to the use of the bi-directional (linear combinational) prediction mode.

Generally, for a to-be-motion-compensated mxn target block of pixels in a QB-picture the preferred embodiments find a reference mxn block (and corresponding motion vector) in each of two prior pictures and select from the resultant three candidate predictions of the target block: (1) the first reference block from the first prior picture, (2) the second reference block from the second prior picture (picture 1), and (3) a pixelwise combination of the first and second reference blocks. The residual (texture) block is then the difference of the target block and the selected prediction block, and the texture may be transformed (e.g., DCT, wavelet, integer) and quantized. The pixelwise combination (3) of the first and second reference blocks may be simple pixelwise averaging or could be weighted such as by temporal distance or motion vector magnitude or some adaptive method. And the choice of which two prior pictures to use could be selected from a set of available prior pictures, such as the immediately preceding five or two pictures, or could be from an adaptive set of prior pictures. The encoding of the QB-picture target block uses the motion vector(s) and the texture (macro)block.

Preferred embodiment communication systems, video encoders, and video decoders use preferred embodiment QB-picture methods.

The preferred embodiment computations and other functions can be performed with digital signal processors (DSP's) or general purpose programmable processors or application specific circuitry (specialized accelerators) alone or as part of a system on a chip such as both a DSP and RISC processor plus accelerator(s) on the same chip with the RISC processor as controller. These chip(s) could include transmission and reception functions for wireless connections as for cellular phones and portable computers. The functions could be a stored program in an onboard or external ROM, flash EEPROM, or ferroelectric RAM for any programmable processors. For video the preferred embodiment methods apply to both macroblocks of Intra-coded frames (i.e. I frames and still images) and of non-Intra frames (Predictive or Bidirectional frames, i.e. P or B frames, respectively) which use run-length coding with variable-length codewords.

2. H.26L-Type Preferred Embodiments

H.26L is an advanced video compression standard being jointly developed by ITU-T and MPEG. FIG. 4(a) depicts the coding structure of the H.26L baseline, in which both I- and P-pictures are supported. A significant difference of the H.26L P-pictures from traditional P-pictures (in MPEG, H.261, H.263, H.263+) is the multiple reference picture prediction. An H.26L P-picture can have more than one reference picture. However, a macroblock is still limited to predict from a macroblock in one reference picture, which could be any of the multiple reference pictures in the past; but the reference picture number indicating which of reference pictures is selected can be changed from macroblock to macroblock. A macroblock-level syntax element “Ref_Frame” is used for such an indication: Ref_Frame=0 means prediction from the last decoded picture (1 picture back), Ref_Frame=1 means two pictures back, and so on.

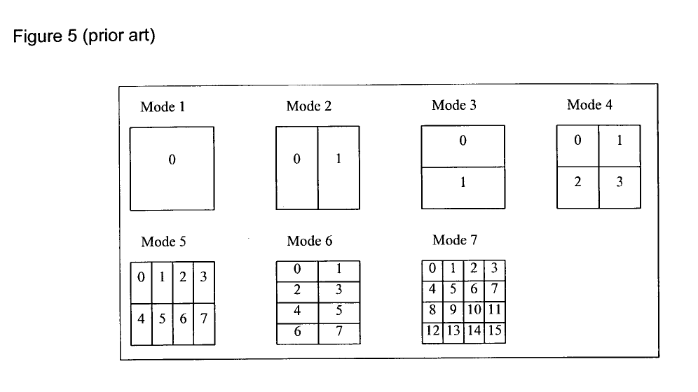

Another significant difference is that the H.26L P-picture modes reflect seven vector block sizes (i.e. partitions of a macroblock into subblocks of size 16×16, 16×8, 8×16, 8×8, 8×4, 4×8, or 4×4, see FIG. 5). The vector block size determines the number of motion vectors needed for a macroblock to do the forward prediction. For example, if vector block size is 16×16, then there is only one 16×16 vector for this macroblock; if vector size is 8×8, then there are four 8×8 vectors for the macroblock, and so on. The index of each mode in FIG. 5 also determines coding order of motion vectors in the bitstream. In FIG. 5 the numbering of the vectors for the different vector block sizes depending on the inter-mode. For each block the horizontal component comes first followed by the vertical component.

The typical number of reference pictures used for H.26L baseline is 5, which leads to a significant increase in both memory requirement and computational complexity. In order to achieve the highest coding efficiency, an H.26L baseline encoder not only has to buffer five reference pictures for P-pictures, but also it needs to do motion estimation for each of five reference pictures, which is extremely time-consuming. On the decoder side, the memory size used for buffering five reference frames will make a decoder expensive.

The preferred embodiments apply QB pictures to the H.26L baseline. As shown FIG. 4(b), all the P-pictures from the 3^{rd} picture on are replaced by the QB-pictures, each QB-picture is predicated from the two most recently encoded reference pictures. In order to minimize the syntax changes, in the bi-directional mode of the QB-picture the macroblock is limited to have the same vector block size (i.e., one of 16×16, 16×8, 8×16, 8×8, 8×4, 4×8, 4×4) for both the reference pictures. With the help of this limitation, “Ref_frame=2” can be used to indicate the bi-directional prediction mode, while “Ref_frame=0” & “Ref_frame=1” are still used to represent the forward prediction mode from the reference picture 0 and 1 as the H.26L P-pictures do. However, in the bi-directional prediction mode the motion vectors of the second reference picture need to be encoded as well, in addition to the motion vectors of the first reference picture.

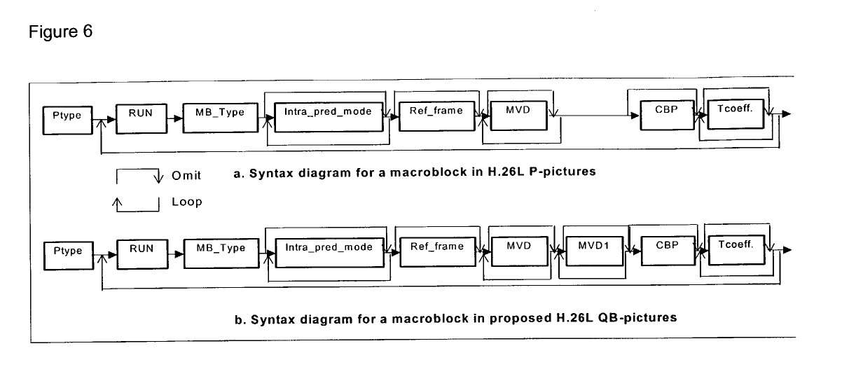

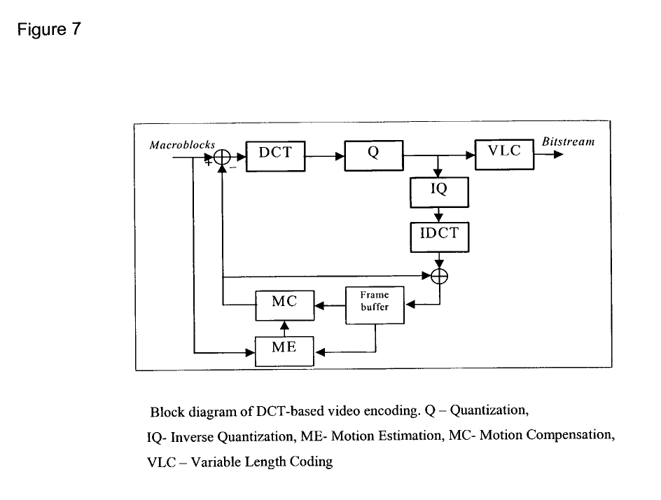

The macroblock-level syntax diagrams of the H.26L P-pictures and the preferred embodiment QB-pictures are compared in FIG. 6. Compared to the H.26L P-pictures, the QB-pictures need a very small syntax modification. Except for the definition of “Ref_frame” and an additional vector coding block, MVD1 in FIG. 6(b), added, everything else remains the same. For a QB-picture, the picture coding type is still P-picture (“Ptype=P”), the skipped macroblock rule is still the same (RUN), the intra prediction mode (intra_pred_mode), coded block pattern (CBP) and DCT-coefficient coding (T_coeff) remain unchanged, and the motion vector coding (MVD) is exactly same as in H.26L P-pictures if a macroblock of a QB-picture uses the forward prediction mode from reference picture 0 or 1. The two major differences are:

Ref_frame: in the H.26L P-pictures Ref_frame can have any value (typically 0 to 4 for baseline, i.e. 5 reference pictures), “Ref_frame=k” means the forward prediction from the kth reference picture (k+1 pictures back). In the QB-pictures, Ref_frame has values of 0, 1 or 2, “Ref_frame=0” and “Ref_frame=1” means the forward prediction from reference picture 0 and 1, respectively. “Ref_frame=2” is used to indicate the bi-directional prediction which averages predictions from reference picture 0 and 1, motion vectors of both reference pictures are transmitted.

MVD1: if a macroblcok of a QB-picture uses the bi-directional mode, the motion vectors of reference picture 0 is encoded in block MVD of FIG. 6, while the motion vectors of reference picture 1 are encoded by using the following pseudo code.

| for (i = 0; i < cnt_vec; i++) | |
|---|---|
| { | DMVX = MVX1[i]- MVX0[i]; |
| | DMVY = MVY1[i] − MVY0[i]; |
| | H26L_MVD_UVLC(DMVX); |
| | H26L_MVD_UVLC(DMVY); |
| } | |

where “cnt_vec” is the number of motion vectors for the current macroblock determined by the vector block size indicated in MB_Type (see also FIG. 5), {(MVX1[i], MVY1[i]) |i=0, 1, . . . cnt_vec−1} and {(MVX0[i], MVY0[i]) |i=0, 1, . . . cnt_vec-1} are block motion vectors of reference picture 1 and reference picture 0, respectively. H26L_MVD_UVLC is the differential vector coding using Universal Variable Length Coding defined in H.26L.

Therefore, in the cases of less than three reference pictures used (1 or 2 reference pictures), the QB-picture is a superset of the H.26L P-picture.

3. Experimental Results

Experiments were carried out to verify the efficiency of the preferred embodiment QB-pictures compared to the H.26L P-pictures. In total six CIF (352×288) sequences, Akiyo, Coastguard, Foreman, Hall_Monitor, Mother_Daughter, News, were used in the simulation. The sequences are encoded at 10 frame/s, 100 pictures each, with six quantization scales (QP=26, 22, 17,12, 8, 4) to simulate a wide range of bit-rates. The coding results were measured for three cases: H.26L baseline with two reference pictures (H.26L_{—}2ref), H.26L baseline with five reference pictures (H.26L_{—}5ref) and H.26L baseline with QB-pictures (H.26L_QB). The coding structure followed the one illustrated in FIG. 3; i.e., only one I-picture at the beginning followed by all P- or QB-pictures. The bit-rates and average PSNR values were computed over the entire sequences.

The experimental results are listed in the following Table. where H.261_QB vs. H.261_{—}2ref and H.261_QB vs. H.261_{—}5ref show the improvements of the preferred embodiment QB-pictures over the H.26L P-pictures in terms of bit-rate reductions at the same qualities and PSNR improvements at the same bit-rates. As shown in the last row of Table 1, in average the proposed method provides about 3% bit-rate reduction (or 0.24 dB PSNR increase), and about 2.2% bit-rate reduction (or 0.13 dB PSNR increase) compared to the H.26L baseline with two and five reference pictures, respectively. The most promising results are in sequence Hall_Monitor, in which peak improvements of about 13% (or 0.75 dB PSNR increase) and about 10% (or 0.59 dB PSNR increase) were measured against the two H.26L baseline cases, respectively.

| | H.26L_2ref | | H.26l_5ref | | H.26l_QB | | | | | |
|---|---|---|---|---|---|---|---|---|---|---|
| | (with 2 reference | | (with 5 reference | | (with Quasi B | | H.26l_QB vs. | | H.26l_QB vs. | |
| | pictures) | | pictures) | | pictures) | | H.26l_2ref | | H.26l_5ref | |
| | bit_rate | PSNR_Y | bit_rate | PSMR_Y | bit_rate | PSNR_Y | Δbit_rate | ΔPSNR | Δbit_rate | ΔPSNR |
| QP | [kbit/s] | [dB] | [kbit/s] | [dB] | [kbit/s] | [dB] | [%] | [dB] | [%] | [dB] |

Akiyo, CIF (352 × 288), 10 frame/s, 100 frames

| | | | | | | | | | | |
|---|---|---|---|---|---|---|---|---|---|---|
| 26 | 22.44 | 33.30 | 22.13 | 33.25 | 22.55 | 33.37 | 1.07 | 0.05 | 0.53 | 0.03 |
| 22 | 34.83 | 35.90 | 33.65 | 35.94 | 34.65 | 36.02 | 2.07 | 0.16 | −1.93 | −0.14 |
| 17 | 63.03 | 39.06 | 60.76 | 39.11 | 61.85 | 39.20 | 3.81 | 0.28 | −0.50 | −0.04 |
| 12 | 121.69 | 42.14 | 117.73 | 42.17 | 118.19 | 42.26 | 4.80 | 0.32 | 1.05 | 0.07 |
| 8 | 213.22 | 44.42 | 207.01 | 44.45 | 204.65 | 44.53 | 5.94 | 0.33 | 2.65 | 0.14 |
| 4 | 373.04 | 46.70 | 363.29 | 46.72 | 357.78 | 46.79 | 5.62 | 0.31 | 2.73 | 0.15 |
| AV | 138.04 | 40.25 | 134.10 | 40.27 | 133.28 | 40.36 | 3.88 | 0.24 | 0.75 | 0.04 |

Coastguard, CIF (352 × 288), 10 frame/s, 100 frames

| | | | | | | | | | | |
|---|---|---|---|---|---|---|---|---|---|---|
| 26 | 165.17 | 28.10 | 168.95 | 28.04 | 164.20 | 28.14 | 2.04 | 0.06 | 5.99 | 0.19 |
| 22 | 297.66 | 30.36 | 298.98 | 30.35 | 294.22 | 30.43 | 2.43 | 0.13 | 3.01 | 0.16 |
| 17 | 615.85 | 33.66 | 614.01 | 33.66 | 605.63 | 33.72 | 2.60 | 0.17 | 2.37 | 0.15 |
| 12 | 1192.90 | 37.37 | 1190.56 | 37.38 | 1167.64 | 37.44 | 2.96 | 0.23 | 2.72 | 0.21 |
| 8 | 1937.13 | 40.65 | 1934.05 | 40.65 | 1892.84 | 40.71 | 2.94 | 0.26 | 2.82 | 0.25 |
| 4 | 2937.14 | 43.84 | 2930.51 | 43.84 | 2865.90 | 43.89 | 2.90 | 0.28 | 2.71 | 0.26 |
| AV | 1190.97 | 35.66 | 1189.51 | 35.65 | 1165.07 | 35.72 | 2.65 | 0.19 | 3.27 | 0.20 |

Foreman, CIF (352 × 288), 10 frame/s, 100 frames

| | | | | | | | | | | |
|---|---|---|---|---|---|---|---|---|---|---|
| 26 | 121.39 | 30.54 | 120.18 | 30.49 | 118.21 | 30.59 | 3.66 | 0.16 | 3.95 | 0.17 |
| 22 | 186.05 | 32.71 | 184.18 | 32.67 | 181.04 | 32.78 | 3.76 | 0.24 | 3.50 | 0.23 |
| 17 | 331.86 | 35.71 | 325.38 | 35.70 | 322.22 | 35.80 | 4.26 | 0.30 | 2.39 | 0.17 |
| 12 | 623.95 | 38.99 | 609.52 | 38.99 | 607.08 | 39.09 | 4.14 | 0.30 | 1.82 | 0.13 |
| 8 | 1058.47 | 41.87 | 1034.33 | 41.87 | 1031.85 | 41.96 | 3.78 | 0.27 | 1.53 | 0.11 |
| 4 | 1718.53 | 44.66 | 1682.92 | 44.66 | 1677.15 | 44.73 | 3.35 | 0.25 | 1.37 | 0.10 |
| AV | 673.37 | 37.41 | 659.42 | 37.40 | 656.26 | 37.49 | 3.83 | 0.25 | 2.43 | 0.15 |

Hall_Monitor, CIF (352 × 288), 10 frame/s, 100 frames

| | | | | | | | | | | |
|---|---|---|---|---|---|---|---|---|---|---|
| 26 | 36.45 | 31.22 | 35.97 | 31.28 | 36.13 | 31.27 | 2.45 | 0.07 | −1.05 | −0.03 |
| 22 | 70.01 | 33.84 | 68.79 | 33.88 | 68.84 | 33.92 | 3.03 | 0.17 | 0.64 | 0.04 |
| 17 | 152.69 | 36.97 | 148.93 | 37.01 | 148.46 | 37.11 | 5.00 | 0.31 | 2.03 | 0.12 |
| 12 | 396.88 | 39.72 | 384.16 | 39.75 | 378.36 | 39.93 | 8.90 | 0.43 | 5.14 | 0.24 |
| 8 | 838.40 | 42.02 | 810.65 | 42.09 | 778.19 | 42.30 | 12.90 | 0.64 | 8.33 | 0.40 |
| 4 | 1597.16 | 44.56 | 1561.01 | 44.59 | 1458.36 | 44.80 | 12.58 | 0.75 | 10.20 | 0.59 |
| AV | 515.26 | 38.05 | 501.59 | 38.10 | 478.06 | 38.22 | 7.48 | 0.40 | 4.22 | 0.23 |

Mother_Daughter, CIF (352 × 288), 10 frame/s, 100 frames

| | | | | | | | | | | |
|---|---|---|---|---|---|---|---|---|---|---|
| 26 | 36.73 | 32.90 | 35.94 | 32.85 | 36.85 | 32.98 | 1.37 | 0.06 | 0.00 | −0.00 |
| 22 | 56.10 | 35.25 | 55.26 | 35.25 | 56.08 | 35.38 | 1.97 | 0.14 | 0.50 | 0.03 |
| 17 | 97.57 | 38.34 | 94.96 | 38.36 | 96.55 | 38.46 | 2.67 | 0.20 | −0.24 | −0.01 |
| 12 | 118.27 | 41.36 | 182.66 | 41.37 | 185.29 | 41.49 | 3.68 | 0.24 | 0.45 | 0.03 |
| 8 | 361.20 | 43.75 | 352.58 | 43.76 | 352.58 | 43.86 | 4.55 | 0.24 | 2.06 | 0.10 |
| 4 | 668.18 | 45.95 | 651.08 | 45.99 | 647.34 | 46.05 | 5.08 | 0.25 | 1.84 | 0.09 |
| AV | 234.67 | 39.59 | 228.75 | 39.60 | 229.11 | 39.70 | 3.22 | 0.19 | 0.77 | 0.04 |

News, CIF (352 × 288), 10 frame/s, 100 frames

| | | | | | | | | | | |
|---|---|---|---|---|---|---|---|---|---|---|
| 26 | 57.08 | 31.19 | 56.60 | 31.18 | 56.46 | 31.24 | 1.95 | 0.09 | 1.46 | 0.07 |
| 22 | 89.57 | 33.89 | 88.67 | 33.89 | 88.43 | 33.94 | 2.02 | 0.15 | 0.93 | 0.07 |
| 17 | 154.24 | 37.38 | 152.88 | 37.37 | 152.02 | 37.46 | 2.37 | 0.20 | 1.57 | 0.13 |
| 12 | 273.55 | 40.77 | 271.28 | 40.78 | 268.55 | 40.86 | 2.91 | 0.23 | 1.94 | 0.15 |
| 8 | 449.12 | 43.45 | 444.94 | 43.46 | 439.59 | 43.53 | 3.25 | 0.23 | 2.21 | 0.15 |
| 4 | 725.14 | 45.93 | 717.85 | 45.94 | 706.85 | 46.00 | 3.61 | 0.24 | 2.39 | 0.16 |
| AV | 291.45 | 38.77 | 288.70 | 38.77 | 285.32 | 38.84 | 2.69 | 0.19 | 1.75 | 0.12 |

Average Result Over Six Test Sequences

| | | | | | | | | | |
|---|---|---|---|---|---|---|---|---|---|
| 507.30 | 38.29 | 500.34 | 38.30 | 491.18 | 38.39 | 3.96 | 0.24 | 2.20 | 0.13 |

Thus the preferred embodiment provides improvement over the H.26L motion compensation.

4. Modifications

The preferred embodiments can be varied while maintaining the feature of two preceding pictures used as references for motion compensation.

For example, the block size for the motion compensation (and any partition modes) could be varied from the 16×16 size macroblock; the number of preceding pictures used as prediction references could be three or more; the averaging of the two reference blocks could be replaced with other combination schemes which weight the preceding pictures differently and may be adaptive and may consider two or more weightings as candidate predictions. Wavelet, integer, and other transform methods could be used in place of DCT with analogous coefficient quantization and run-length plus variable length encoding. The minimizations to find motion vectors could be, in part, a joint minimization over both reference blocks and motion vectors,

What is claimed is:

1. A method of motion compensation, comprising:
(a) providing a target block;
(b) finding a first reference block and first motion vector for said target block, said first reference block in a reconstructed first picture, said first picture preceding said target block;
(c) finding a second reference block and first motion vector for said target block, said second reference block in a reconstructed second picture, said second picture preceding said first picture; and
(d) finding a prediction block for said target block by comparing said first reference block, said second reference block, and a linear combination of said first and second reference blocks.

2. The method of claim 1, wherein:
(a) said first picture immediately precedes a current picture, said target block in said current picture; and
(b) said second picture immediately precedes said first picture.

3. The method of claim 1, wherein:
(a) said linear combination is an average.

4. The method of claim 1, wherein:
(a) each of said target block, first reference block, and second reference block has size selected from 16×16, 16×8, 8×16, 8×8, 8×4, 4×8, or 4×4.

5. The method of claim 1, wherein:
(a) said target block is a subblock of a macroblock.

6. A video encoder, comprising:
(a) a motion compensator;
(b) a residual transformer coupled to an output of said motion compensator;
(c) a quantizer coupled to the output of said transformer;
(d) a variable length encoder coupled to an output of said quantizer;
(e) an inverse quantizer coupled to said output of said quantizer;
(f) an inverse transformer coupled to an output of said inverse quantizer and to an input of said motion compensator;
(g) wherein said motion compensator includes target block prediction using a candidate prediction block formed as a linear combination of a first reference block in a reconstructed first picture preceding said target block and a second reference block in a reconstructed second picture preceding said first picture.
